(19) United States
(12) Patent Application Publication
(10) Pub. No.: US 2007/0189772 A1
(43) Pub. Date: Aug. 16, 2007

(54) Hybrid passive optical network using wireless communication

(75) Inventors: Yoo-Jeong Hyun, Seongnam-si (KR); Dong-Jae Shin, Seoul (KR); Dae-Kwang Jung, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/600,971

(22) Filed: Nov. 17, 2006

(30) Foreign Application Priority Data
Feb. 10, 2006 (KR) 13049/2006

(51) Int. Cl. H04J 14/00

(52) U.S. Cl. 398/71; 398/72

(57) ABSTRACT

Provided is a hybrid Passive Optical Network (PON) using a wireless communication. The hybrid PON includes a Central Office (CO) for transmitting downstream optical signals, a Remote Node (RN) for performing wavelength division demultiplexing of the downstream optical signals received from the CO and power-splitting each of the demultiplexed downstream optical signals to generate a plurality of downstream optical signals, transmitting the plurality of downstream optical signals to Optical Network Units (ONUs) of a corresponding group, generating a corresponding upstream optical signal modulated with wirelessly received upstream subcarriers of a corresponding group, and transmitting a plurality of generated upstream optical signals to the CO, and ONUs forming a plurality of groups for acquiring downstream subcarriers of a corresponding group from a corresponding downstream optical signal received from the RN, acquiring a corresponding downstream subcarrier by filtering downstream subcarriers of the group, and wirelessly transmitting a corresponding upstream subcarrier to the RN.

### CLAIM OF PRIORITY

This application claims the benefit of the earlier filing date, under 35 U.S.C. §119, to that patent application entitled “Hybrid Passive Optical Network Using Wireless Communication,” filed in the Korean Intellectual Property Office on Feb. 10, 2006 and assigned Serial No. 2006-13049, the contents of which are incorporated herein by reference.

### BACKGROUND OF THE INVENTION

1. Field of the Invention

The present invention generally relates to a passive optical network, and in particular, to a hybrid passive optical network combining wavelength division multiplexing/subcarrier multiplexing types.

2. Description of the Related Art

Wavelength Division Multiplexed Passive Optical Network (WDM-PON) is gaining more attraction as a next-generation network for a future broadband communication service. The WDM-PON is a technique for transmitting a plurality of optical signals having different wavelengths over a single optical path in a wavelength band (e.g., 1300-1600 nm). With the demand for broadband services such as digital TVs (HDTVs), remote education, and video telephony from subscribers, the bandwidth required for each subscriber is increasing and a data transfer rate required for each subscriber can reach several hundreds of Mb/s. Thus, the WDM-PON is attractive because it allocates a separate wavelength to each subscriber. Since the WDM-PON has no limit in a bandwidth, it can provide a large bandwidth (transmission rates) of up to several gigabits per second (Gb/s) and has excellent security and protocol independence. However, the WDM-PON has not yet been commercialized due to high cost and research is being actively conducted on a low-cost WDM-PON.

Subcarrier Multiplexing (SCM) is a technique for modulating a carrier with a data signal, such as a digital video signal, an analog video signal, or an Internet signal (hereinafter, the modulated carrier will be referred to as a subcarrier), generating an optical signal by modulating light of a predetermined wavelength with the subcarrier, and transmitting the generated optical signal. In a WDM/SCM-PON, a plurality of Optical Network Units (ONUs) transmits upstream optical signals of the same wavelength to a Central Office (CO) through a Remote Node (RN). The ONU refers to a device provided to a subscriber. Since SCM can use a large bandwidth of an optical fiber through a plurality of subcarriers, it can provide mass video and data services, provide the services to more subscribers using an optical amplifier and an optical Power Splitter (PS), and easily provide various kinds of services through subcarriers. Since all ONUs transmit upstream optical signals using a relatively inexpensive Fabry-Perot laser that is robust to Optical Beat Interference (OBI), wavelength management is easy in upstream and downstream transmission. However, the CO has to modulate a downstream optical signal using an expensive optical modulator having superior linearity because a large number of subcarriers have to be transmitted with a high signal to noise ratio for mass video and data services, and has to transmit a high-power downstream optical signal using an optical amplifier in order for an optical receiver included in each ONU to receive the high-power downstream optical signal. Moreover, since all the ONUs could share a single wavelength for downstream transmission, the CO divides a unit time band (hereinafter referred to as a cycle) for downstream transmission for allocation to each ONU and transmits a downstream optical signal to each ONU in an allocated time band (hereinafter referred to as a time slot). Thus, the amount of data transmitted to each ONU is limited. Furthermore, since all ONUs could share a single wavelength for upstream transmission, the CO divides a cycle for upstream transmission for allocation to each ONU and each ONU transmits an upstream optical signal in its allocated time slot. Thus, the amount of data transmitted by each ONU is limited. In other words, each ONU cannot transmit an upstream optical signal in another time slot except for its allocated time slot.

Recently, a hybrid PON combining WDM/SCM types has been in the spotlight. In the hybrid PON, an RN (Remote Node) splits each downstream optical signal that is demultiplexed by a 1*N wavelength division multiplexer, by using a 1*N optical power splitter. At this time, a single downstream optical signal is modulated with M subcarriers. As a result, since M subcarriers can be acquired from each of N downstream optical signals, N*M subscribers can be served and therefore, a cost for each subscriber would be reduced by M times when compared to a general WDM-PON.

FIG. 1 illustrates a typical hybrid PON 100 combining WDM/SCM types. The hybrid PON 100 includes a CO 110, an RN 150, and ONUs 190-1-1-190-N-M included in first through N groups 180-1-180-N.

The CO 110 includes N optical transceivers (TRX) 120-1-120-N and a first Wavelength Division Multiplexer (WDM) 130.

TRXs 120-1-120-N have the same configuration and are sequentially connected to corresponding Demultiplexing Ports (DMPs) of the first WDM 130 based on one-to-one correspondence. The TRXs 120-1-120-N output corresponding downstream optical signals and receive first through N^{th} upstream optical signals. The downstream optical signals have wavelengths λ₁-λ_{N} and each of the downstream optical signals is modulated with M downstream subcarriers forming each group. In other words, first through M^{th} downstream subcarriers included in an N^{th} group have frequencies f₁-f_{M} and are modulated with first through M^{th} downstream data signals included in an N^{th} group. The downstream subcarriers and the downstream data signals are all electric signals. The upstream optical signals have non-overlapping wavelengths λ_{(N+1)}-λ_{2N} and each of the upstream optical signals is modulated with M upstream subcarriers forming each group. In other words, first through M^{th} upstream subcarriers included in an N^{th} group have frequencies f₁-f_{M} and are modulated with first through M^{th} upstream data signals included in an N^{th} group. The upstream subcarriers and the upstream data signals are all electric signals.

With reference to the N^{th} TRX 120-N, which is typical of all the other TRX illustrated herein, TRX 120-N includes a Downstream Light Source (DLS) 122-N, an upstream optical receiver (URX) 124-N, and an Optical Coupler (CP) 126-N.

DLS 122-N generates an downstream optical signal of a known wavelength, (in this exemplary case, the wavelength is λ_{N}, an N^{th} wavelength) and outputs the N^{th} downstream optical signal to the N^{th} optical coupler 126-N. The N^{th} downstream optical signal is modulated with first through M^{th} downstream subcarriers associated with the N^{th} group and the downstream subcarriers which have been modulated downstream data signals.

URX 124-N receives an N^{th} upstream optical signal from the N^{th} CP 126-N and acquires the first through N^{th} upstream subcarriers to obtain the M upstream data signals.

CP 126-N includes first through third ports, in which the first port is connected with a Demultiplexing port of the first WDM 130, the second port is connected with the URX 124-N, and the third port is connected with the DLS 122-N. The CP 126-N outputs an N^{th} upstream optical signal input to the first port to the second port and outputs an N^{th} downstream optical signal input to the third port to the first port.

As noted above, each of the TRX 120-1 through 120-N is similar in construction and thus a detailed description of each TRX need not be presented herein.

The first WDM 130 includes a Multiplexing Port (MP) and N DMPs, in which the MP is connected with a feeder fiber 140 and the first through N^{th} DMPs are connected with the first through N^{th} TRXs 120-1-120-N based on one-to-one correspondence. The first WDM 130 de-multiplexes N upstream optical signals input to the MP and outputs the results on corresponding first through N^{th} DMPs based on one-to-one correspondence and further performs multiplexes the on N downstream optical signals input to the first through N^{th} DMPs to output the results to the MP.

The RN 150 is connected to the CO 110 through the feeder fiber 140 and is further connected to each of the ONUs 190-1-1-190-N-M of the first through N^{th} groups 180-1-180-N through distribution optical fibers associated with the respective group. Each of the first through N^{th} groups 180-1-180-N includes first through M^{th} distribution optical fibers. The RN 150 includes a second WDM 160 and first through N^{th} PSs 170-1-170-N.

The second WDM 160 has an MP and first through N^{th} DMPs, in which the MP is connected with the feeder fiber 140 and the first through N^{th} DMPs are connected with the first through N^{th} PSs 170-1-170-N based on one-to-one correspondence. The second WDM 160 performs de-multiplexing on first through N^{th} downstream optical signals input to the MP to output the results to the first through N^{th} DMPs based on one-to-one correspondence and performs multiplexing of the first through N^{th} upstream optical signals input to the first through N^{th} DMPs to output the results to the MP.

The first through N^{th} PSs 170-1-170-N are connected with corresponding ones of the first through N^{th} DMPs of the second WDM 160.

Referring to the N^{th} PS 170-N, which is typical of all the illustrated splitters, the N^{th} PS 170-N has an Upstream Port (UP) and first through M^{th} Downstream Ports (DPs), in which the UP is connected with the N^{th} DMP of the second WDM 160 and the first through M^{th} DPs are connected with distribution optical fibers of the N^{th} group 180-N based on a one-to-one correspondence. The N^{th} PS 170-N power-splits an N^{th} downstream optical signal input to the UP (in this case, λ_{N}) into M portions and outputs the M portions to the first through M^{th} DPs. The N^{th} PS 170-N combines M upstream optical signals input to the first through M^{th} DPs to output the result to the UP on a selected upstream optical signal (in this case, λ_{2N}).

As noted above, each of the power splitters 170 are identical in construction and there is no need to describe each one in detail herein.

The ONUs 190-1-1-190-N-M have the same configuration and each of the first through N^{th} groups 180-1-180-N have the same configuration. Each of the ONU groups 180-1 through 180-N include M ONUs (e.g., 190-1-1-190-1-M) that are connected with distribution optical fibers based on one-to-one correspondence.

With reference to the M^{th} ONU of the N^{th} group 190-N-M this ONU includes a Frequency Modulator (MOD) 191-N-M, an upstream light source 192-N-M, a downstream optical receiver (DRX) 193-N-M, a Bandpass Filter (BPF) 194-N-M, and a CP 195-N-M.

The MOD 191-N-M generates and outputs an upstream subcarrier corresponding to the M^{th} ONU of this N^{th} group, which is modulated with an M^{th} upstream data signal DN-M and has an M^{th} frequency (fₘ).

The M^{th} upstream light source 192-N-M generates and outputs an N^{th} upstream optical signal that is modulated with an M^{th} subcarrier of the N^{th} group and has a wavelength, in this case, of λ_{2N}.

The M^{th} downstream DRX 193-N-M receives an N^{th} downstream optical signal from the M^{th} CP 195-N-M and acquires first through M^{th} downstream subcarriers of an N^{th} group from the N^{th} downstream optical signal.

The M^{th} BPF 194-N-M outputs an M^{th} downstream subcarrier acquired by filtering the first through M^{th} downstream subcarriers of the N^{th} group input from the M^{th} downstream DRX 193-N-M. The first through (M-1)^{th} downstream subcarriers are removed by the Mth BPF 194-N-M.

The M^{th} CP 195-N-M includes first through third ports, in which the first port is connected with a corresponding distribution optical fiber of the N^{th} group 180-N, the second port is connected with the M^{th} DRX 193-N-M, and the third port is connected with the M^{th} upstream light source 192-N-M. The M^{th} CP 195-N-M outputs the N^{th} downstream optical signal input to the first port to the second port and outputs the N^{th} upstream optical signal input to the third port to the first port.

However, the hybrid PON 100 has the following problems.

First, the hybrid PON 100 can increase the number of subscribers by M times when compared to a general WDM-PON, but each ONU has to include a separate light source for upstream transmission. As a result, the number of upstream light sources also increases by M times and thus, a cost for implementing the entire PON increases.

Second, when upstream optical signals output from different optical network devices of the same group are simultaneously input to each upstream optical receiver of the CO 110, the performance of the entire PON may degrade due to Optical Beat Interference (OBI). At this time, it is assumed that at least one of the upstream optical signals has a wavelength error. In other words, a photodiode used as the upstream optical receiver has a square-law photo-detection property, which causes OBI. Optical current output form the photodiode due to the input of the optical signal is proportional to optical power and the optical power is expressed by a square of an optical field. Thus, when upstream optical signals of the same group having different wavelengths are input to the photodiode, a noise is generated around a frequency corresponding to a frequency difference.

The following equations assume that first and second optical signals having different wavelengths are input to a photodiode at the same time.

i(t)=R*I(t)=R·L{ε²(t)} (1)

$$\begin{matrix}I ( t ) = {I}_{1} ( t ) + {I}_{2} ( t ) + 2 \sqrt{{I}_{1} ( t ) {I}_{2} ( t )} - \\ cos [ ( {ω}_{o 1} - {ω}_{o 2} ) t + {φ}_{1} ( t ) - {φ}_{2} ( t ) ] \\ = {I}_{1} ( t ) + {I}_{2} ( t ) + {I}_{x} ( t ) ,\end{matrix} \qquad ( 2 )$$

where t indicates a time, i(t) indicates optical current, R indicates the responsivity of the photodiode, I(t) indicates optical power, ε(t) indicates an optical field, L{ε²(t)} indicates a function expressing I(t) by using ε(t) as a variable, I₁(t) and I₂(t) indicate powers of the first and second optical signals, Iₓ(t) indicates the power of a noise, ωₒ₁ and ωₒ₂ indicate frequencies of the first and second optical signals, and φ₁ and φ₂ indicate frequencies of the first and second optical signals.

The OBI is regarded as a serious problem to be solved in a hybrid PON combining WDM/SCM types, together with a cost for implementing the PON.

### SUMMARY OF THE INVENTION

It is, therefore, an object of the present invention to provide a hybrid PON combining WDM/SCM types, which is capable of minimizing OBI.

It is another object of the present invention to provide a hybrid PON combining WDM/SCM types, which is capable of minimizing OBI and has a self-healing function.

According to one aspect of the present invention, there is provided a hybrid Passive Optical Network (PON) using a wireless communication. The hybrid PON includes a Central Office (CO) for transmitting downstream optical signals, a Remote Node (RN) for performing wavelength division demultiplexing on the downstream optical signals received from the CO and power-splitting each of the demultiplexed downstream optical signals to generate a plurality of downstream optical signals, transmitting the plurality of downstream optical signals to Optical Network Units (ONUs) of a corresponding group, generating a corresponding upstream optical signal modulated with wirelessly received upstream subcarriers of a corresponding group, and transmitting a plurality of generated upstream optical signals to the CO, and ONUs forming a plurality of groups for acquiring downstream subcarriers of a corresponding group from a corresponding downstream optical signal received from the RN, acquiring a corresponding downstream subcarrier by filtering downstream subcarriers of the group, and further wirelessly transmitting a corresponding upstream subcarrier to the RN.

### BRIEF DESCRIPTION OF THE DRAWINGS

The above features and advantages of the present invention will become more apparent from the following detailed description when taken in conjunction with the accompanying drawings in which:

FIG. 1 illustrates a typical hybrid PON combining WDM/SCM types;

FIG. 2 illustrates a hybrid PON combining WDM/SCM types according to a first embodiment of the present invention;

FIG. 3 illustrates in detail a Central Office (CO) illustrated in FIG. 2;

FIG. 4 illustrates a hybrid PON combining WDM/SCM types according to a second embodiment of the present invention; and

FIG. 5 illustrates in detail a CO illustrated in FIG. 4.

### DETAILED DESCRIPTION

Exemplary embodiments of the present invention will now be described in detail with reference to the annexed drawings. For the purposes of clarity and simplicity, a detailed description of known functions and configurations incorporated herein has been omitted for conciseness.

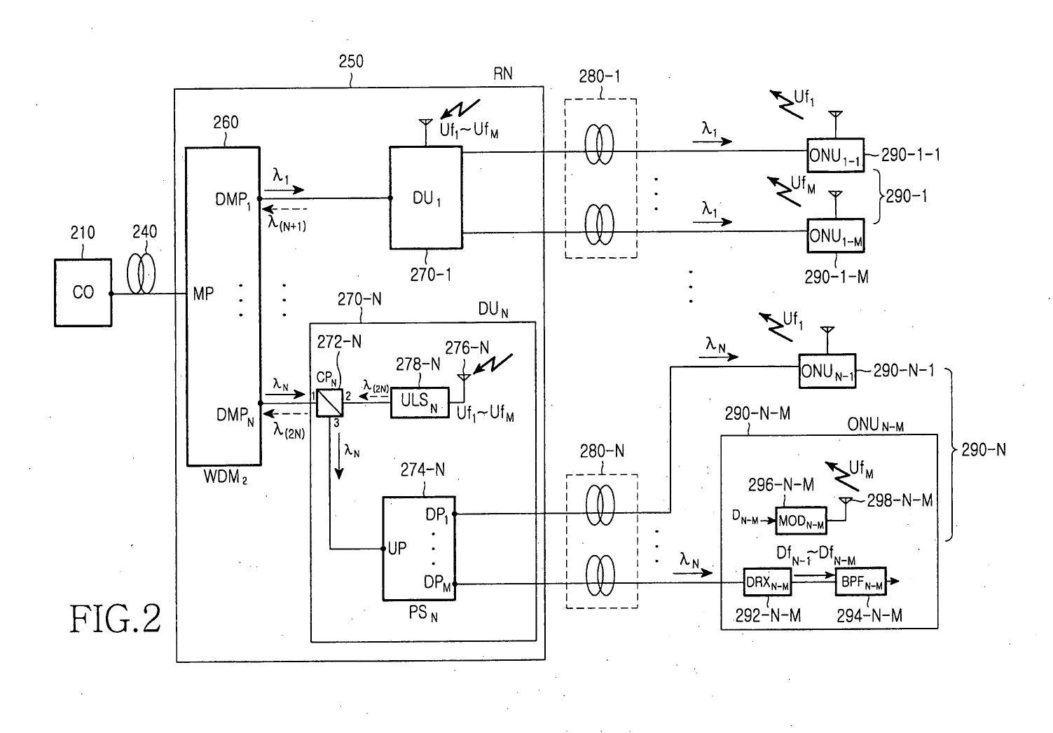

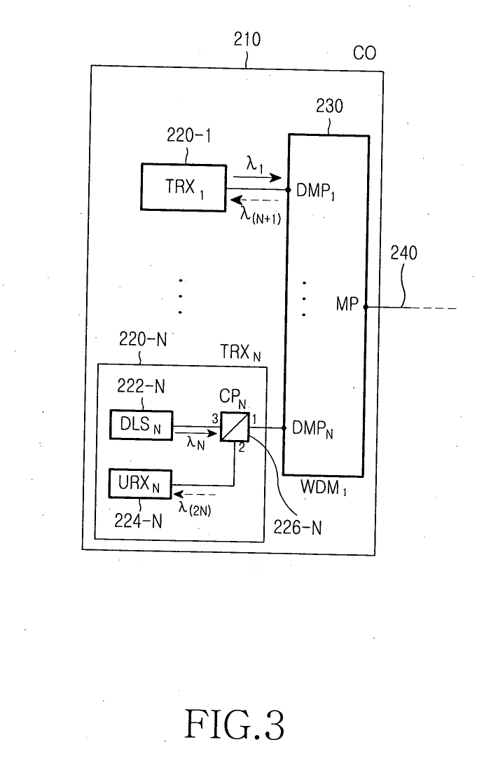

FIG. 2 illustrates a hybrid PON 200 combining WDM/SCM types according to a first embodiment of the present invention, and FIG. 3 illustrates in detail a Central Office (CO) 210 illustrated in FIG. 2. The hybrid PON 200 includes the CO 210, a Remote Node (RN) 250, first through N^{th} groups 280-1-280-N, and Optical Network Units (ONUs) 290-1-1-290-N-M.

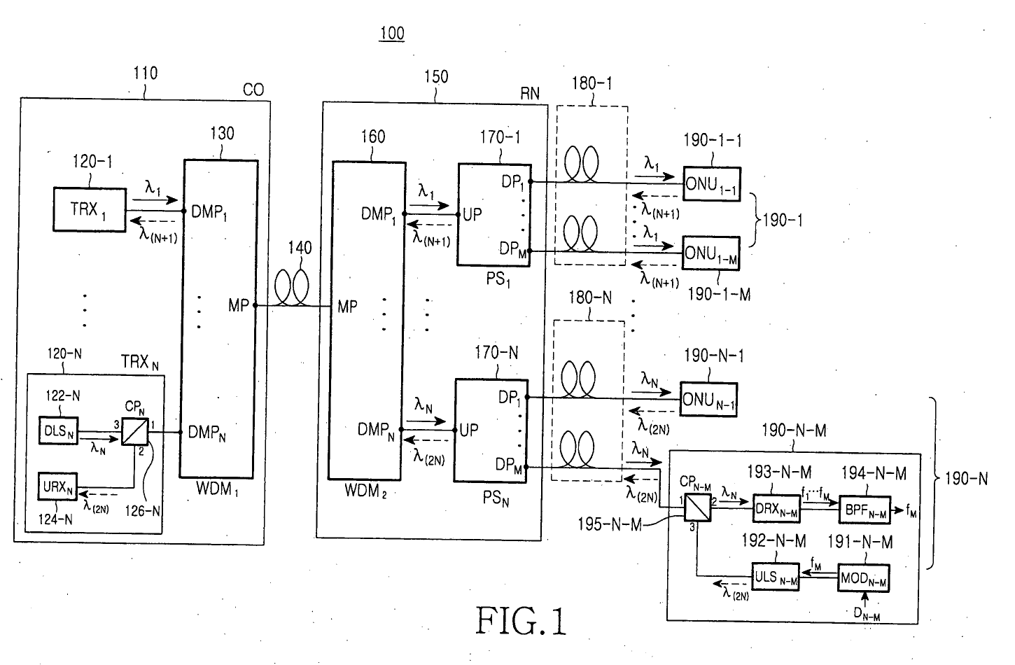

The CO 210 includes first through N^{th} optical transceivers (TRX) 220-1-220-N and a first Wavelength Division Multiplexer (WDM) 230, as described with regard to FIG. 1.

The first through N^{th} TRXs 220-1-220-N have the same configuration and are connected with first through N^{th} demultiplexing ports of the first WDM 230 based on one-to-one correspondence. The first through N^{th} TRXs 220-1-220-N output first through N^{th} downstream optical signals and receive first through N^{th} upstream optical signals, respectively. The first through N^{th} downstream optical signals have first through N^{th} wavelengths λ₁-λ_{N} and each of the first through N^{th} downstream optical signals is modulated with M downstream subcarriers forming each group. In other words, first through M^{th} downstream subcarriers included in an N^{th} group have first through M^{th} frequencies Df₁-Df_{M} and are modulated with first through M^{th} downstream data signals included in an N^{th} group. The downstream subcarriers and the downstream data signals are all electric signals. The first through N^{th} upstream optical signals have wavelengths λ_{(N+1)}-λ_{2N} and each of the first through N^{th} upstream optical signals is modulated with M upstream subcarriers forming each group. In other words, first through M^{th} upstream subcarriers included in an N^{th} group have first through M^{th} frequencies Uf₁-Uf_{N-M} and are modulated with first through M^{th} upstream data signals included in an N^{th} group. The upstream subcarriers and the upstream data signals are all electric signals. The N^{th} TRX 220-N includes an N^{th} Downstream Light Source (DLS) 222-N, an N^{th} upstream optical receiver (URX) 224-N, and an N^{th} Optical Coupler (CP) 226-N.

Referring to FIG. 3, and with reference to the N^{th} TRX 220-N, this TRX 220-N includes DLS 222-N that generates an N^{th} downstream optical signal of an N^{th} wavelength and outputs the N^{th} downstream optical signal to the N^{th} CP 226-N, and the N^{th} downstream optical signal is modulated with first through M^{th} downstream subcarriers of an N^{th} group and the downstream subcarriers of the N^{th} group are modulated with first through M^{th} downstream data signals of an N^{th} group. The N^{th} DLS 222-N may be a Fabry-Perot laser or a Distributed Feedback Laser Diode (DFB-LD).

The N^{th} URX 224-N receives an N^{th} upstream optical signal from the N^{th} CP 226-N and acquires first through M^{th} upstream subcarriers of an N^{th} group and then first through M^{th} upstream data signals of an N^{th} group from the N^{th} upstream optical signal. The N^{th} URX 224-N may be a combination of a photodiode for optoelectric conversion and a demultiplexer for frequency divisional demultiplexing.

The N^{th} CP 226-N has first through third ports, in which the first port is connected to an N^{th} DMP of the first WDM 230, the second port is connected to the N^{th} URX 224-N, and the third port is connected to the N^{th} DLS 222-N. The N^{th} CP 226-N outputs an N^{th} upstream optical signal input to the first port to the second port and outputs an N^{th} downstream optical signal input to the third port to the first port.

The first WDM 230 includes a Multiplexing Port (MP) and first through N^{th} Demultiplexing Ports (DMPs), in which the MP is connected with a feeder fiber 240 and the first through N^{th} DMPs are connected with the first through N^{th} TRXs 220-1-220-N based on one-to-one correspondence. The first WDM 230 performs de-multiplexing on first through N^{th} upstream optical signals received from the RN 250 to output the results to the first through N^{th} DMPs based on one-to-one correspondence and performs multiplexing on first through N^{th} downstream optical signals input to the first through N^{th} DMPs to output the results to the RN 250. The first WDM 230 may be a 1*N arrayed waveguide grating (AWG).

The RN 250, (see FIG. 2) is connected with the CO 210 through the feeder fiber 240 and is connected with the ONUs 290-1-1-290-N-M of the first through N^{th} groups 280-1-280-N through corresponding distribution optical fibers. Each of the first through N^{th} groups 280-1-280-N includes M distribution optical fibers. The RN 250 includes a second WDM 260 and first through N^{th} distribution units (DUs) 270-1-270-N.

The second WDM 260 has an MP and first through N^{th} DMPs, in which the MP is connected with the feeder fiber 240 and the first through N^{th} DMPs are connected with the first through N^{th} DUs 270-1-270-N based on a one-to-one correspondence. The second WDM 260 performs demultiplexing on first through N^{th} downstream optical signals received from the CO 210 to output the results to the first through N^{th} DUs 270-1-270-N based on a one-to-one correspondence and performs multiplexing of the first through N^{th} upstream optical signals input from the first through N^{th} DUs 270-1-270-N to output the results to the CO 210.

The first through N^{th} DUs 270-1-270-N have the same configuration. With reference to the N^{th} DU 270-N, which is typical of the remaining DUs, DU 270-N includes a CP 272-N, a Power Splitter (PS) 274-N, an Upstream Light Source (ULS) 278-N, and an upstream antenna 276-N.

The corresponding CP 272-N includes first through third ports, in which the first port is connected with an N^{th} DMP of the second WDM 260, the second port is connected with the N^{th} PS 274-N, and the third port is connected with the N^{th} ULS 278-N. The N^{th} CP 272-N outputs an N^{th} downstream optical signal input from the second WDM 260 to the N^{th} PS 274-N and outputs an N^{th} upstream optical signal input from the N^{th} ULS 278-N to the second WDM 260.

The N^{th} PS 274-N, which is typical of the remaining power splitters, includes an Upstream Port (UP) and first through M^{th} Downstream Ports (DPs), in which the UP is connected with the second port of the N^{th} CP 272-N and the first through M^{th} DPs are connected with distribution optical fibers of the N^{th} group 280-N based on a one-to-one correspondence. The N^{th} PS 274-N power-splits an N^{th} downstream optical signal input from the N^{th} CP 272-N into M signals and outputs the M signals to the first through M^{th} DPs.

The N^{th} upstream antenna 276-N is connected with an end of the N^{th} ULS 278-N and outputs first through M^{th} upstream subcarriers of an N^{th} group received wirelessly from first through M^{th} ONUs 290-N-1-290-N-M of the N^{th} group 280-N to the N^{th} ULS 278-N.

One end of the N^{th} ULS 278-N is connected with the N^{th} upstream antenna 276-N and the other end is connected with the third port of the N^{th} CP 272-N. The N^{th} ULS 278-N generates the N^{th} upstream optical signal of wavelength (λ_{2N}), which is modulated with the first through M^{th} upstream subcarriers, and outputs the N^{th} upstream optical signal to the N^{th} CP 272-N. The N^{th} ULS 278-N may be a Fabry-Perot laser.

The ONUs 290-1-1-290-N-M of the first through N^{th} groups 290-1-290-N have the same configuration. In other words, the N^{th} group 280-N includes first through M^{th} ONUs 290-N-1-290-N-M that are connected with first through M^{th} distribution optical fibers of an N^{th} group 280-N based on one-to-one correspondence. The M^{th} ONU 290-N-M, which his typical of the remaining ONUs, of the N^{th} group 290-N includes a downstream optical receiver (DRX) 292-N-M, a Bandpass Filter (BPF) 294-N-M for isolating a specific frequency (fₘ), an M^{th} frequency modulator (MOD) 269-N-M, and an M^{th} upstream antenna 298-N-M.

One end of the M^{th} DRX 292-N-M is connected with an M^{th} distribution optical fiber of the N^{th} group 280-N and the other end is connected with the N^{th} BPF 294-N-M. The M^{th} DRX 292-N-M acquires first through M^{th} downstream subcarriers of an N^{th} group from an N^{th} downstream optical signal received from the RN 250. The M^{th} DRX 292-N-M may be a photodiode for opto-electric conversion.

The M^{th} BPF 294-N-M receives first through M^{th} downstream subcarriers of an N^{th} group from the M^{th} DRX 292-N-M and outputs an M^{th} downstream subcarrier acquired by filtering downstream subcarriers of the N^{th} group. The first through (M-1)^{th} downstream subcarriers are removed by the M^{th} BPF 294-N-M.

The M^{th} frequency modulator 296-N-M is connected with the M^{th} upstream antenna 298-N-M and generates an M^{th} subcarrier of an N^{th} group having an M^{th} upstream frequency of an N^{th} group, which is modulated with an M^{th} upstream data signal of an N^{th} group, to output the M^{th} subcarrier to the M^{th} antenna 298-N-M.

The M^{th} upstream antenna 298-N-M transmits an M^{th} upstream subcarrier of an N^{th} group input from the M^{th} frequency modulator 296-N-M to the RN 250 wirelessly.

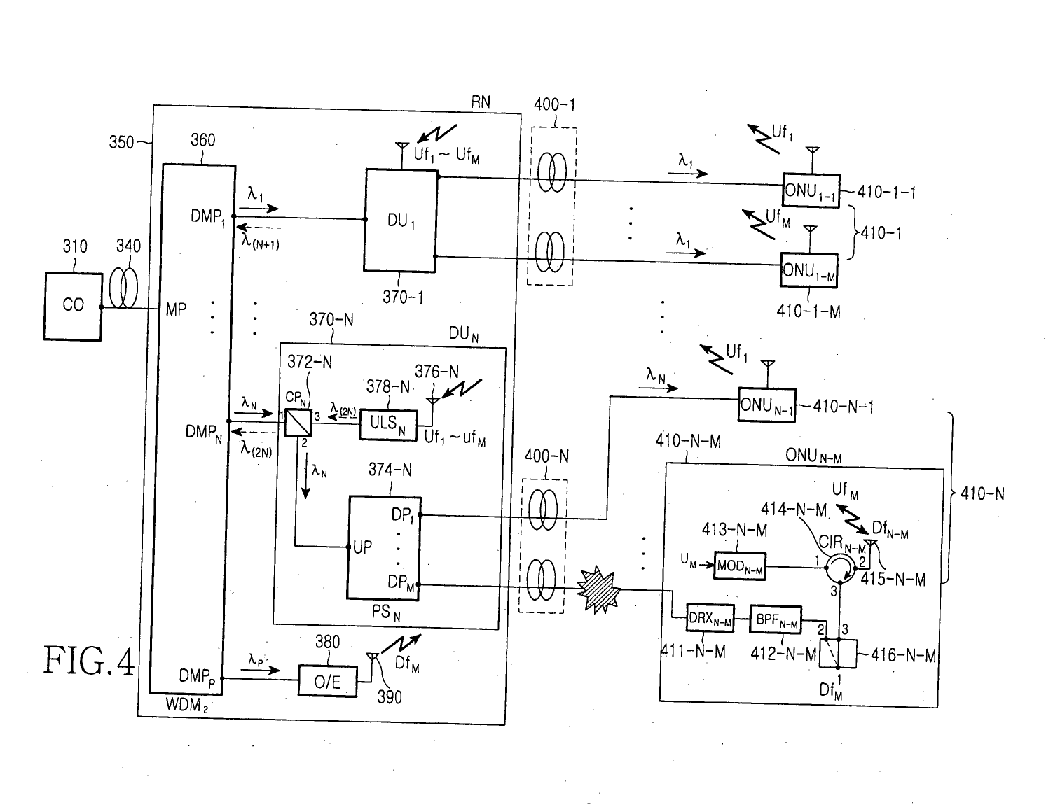

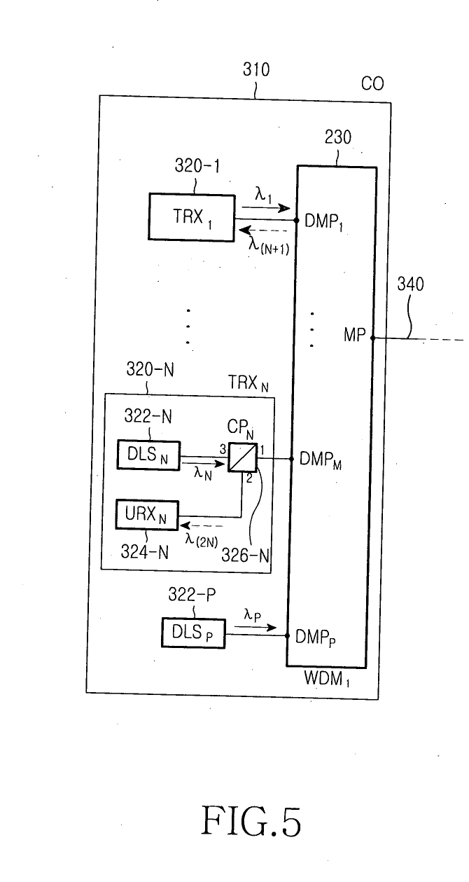

FIG. 4 illustrates a hybrid PON 300 combining WDM/SCM types according to a second embodiment of the present invention, and FIG. 5 illustrates in detail a CO 310 illustrated in FIG. 4. The hybrid PON 300 has a similar configuration to the hybrid PON 200 of FIG. 2 except that it further includes a self-healing means. The hybrid PON 300 includes the CO 310, an RN 350, and first through M^{th} ONUs 410-1-1-410-N-M of first through N^{th} groups 410-1-410-N. Hereinafter, a case where an M^{th} distribution optical fiber of an N^{th} group 400-N, which connects the RN 350 and the M^{th} ONU 410-N-M of the N^{th} group 410-1, is broken will be taken as an example.

Referring to FIG. 3, the CO 310 includes a P^{th} Downstream Light Source (DLS) 322-P, first through N^{th} optical transceivers (TRX) 320-1-320-N, and a first WDM 330.

The first through N^{th} TRX 320-1-320-N have the same configuration and are connected with first through N^{th} Demultiplexing Ports (DPs) of the first WDM 330 based on a one-to-one correspondence. The first through N^{th} TRX 320-1-320-N output first through N^{th} downstream optical signals and receive first through N^{th} upstream optical signals. The first through N^{th} downstream optical signals have first through N^{th} wavelengths λ₁-λ_{N} and each of the first through N^{th} downstream optical signals is modulated with M or (M-1) downstream subcarriers forming each group. First through M^{th} downstream subcarriers included in an N^{th} group have first through M^{th} downstream frequencies Df₁-Df_{M} and are modulated with first through M^{th} downstream data signals included in an N^{th} group. The downstream subcarriers and the downstream data signals are all electric signals. The first through N^{th} upstream optical signals have wavelengths λ_{(N+1)}-λ_{2N} and each of the first through N^{th} upstream optical signals is modulated with M upstream subcarriers forming each group. In other words, first through M^{th} upstream subcarriers included in an N^{th} group have first through M^{th} upstream frequencies Uf₁-Uf_{M} and are modulated with first through Mₜₕ upstream data signals included in an Nₜₕ group. The upstream subcarriers and the upstream data signals are all electric signals. The N^{th} TRX 320-N includes an N^{th} Downstream Light Source (DLS) 322-N, an N^{th} upstream optical receiver (URX) 324-N, and an N^{th} Optical Coupler (CP) 326-N.

The N^{th} DLS 322-N generates an N^{th} downstream optical signal of an N^{th} wavelength and outputs the N^{th} downstream optical signal to the N^{th} CP 326-N, and the N^{th} downstream optical signal is modulated with first through (M-1)^{th} downstream subcarriers of an N^{th} group and the downstream subcarriers of the N^{th} group are modulated with first through (M-1)^{th} downstream data signals of an N^{th} group.

The N^{th} URX 324-N receives an N^{th} upstream optical signal from the N^{th} CP 326-N and acquires first through M^{th} upstream subcarriers of an N^{th} group and then first through M^{th} upstream data signals of an N^{th} group from the N^{th} upstream optical signal.

The N^{th} CP 326-N includes first through third ports, in which the first port is connected with an N^{th} DMP of the first WDM 330, the second port is connected with the N^{th} URX 324-N, and the third port is connected with the N^{th} DLS 322-N. The N^{th} CP 326-N outputs an N^{th} upstream optical signal input to the first port to the second port and outputs an N^{th} downstream optical signal input to the third port to the first port.

The P^{th} DLS 322-P is connected with a P^{th} DMP of the first WDM 330. The P^{th} DLS 322-P does not operate in a normal mode, but operates in a protection mode in which a failure occurs in a distribution optical fiber or an ONU and thus downstream transmission of a downstream subcarrier to the ONU having the failure is not possible. The P^{th} DLS 322-P outputs a P^{th} downstream optical signal of a P^{th} wavelength λ_{P} to the first WDM 330. The P^{th} downstream optical signal is modulated with the downstream subcarrier destined to the ONU having the failure. In the second embodiment of the present invention, since the M^{th} ONU 410-N-M of the N^{th} group 410-1 has the failure, the P^{th} downstream optical signal is modulated with the M^{th} downstream subcarrier and the M^{th} downstream subcarrier is modulated with the M^{th} downstream data signal of an N^{th} group.

The first WDM 330 includes an MP and first through P^{th} DMPs, in which the MP is connected with a feeder fiber 340, the first through P^{th} DMPs are connected with the first through N^{th} TRX 320-1-320-N, and the P^{th} DMP is connected with the P^{th} DLS 322-P. The first WDM 330 performs de-multiplexing on first through N^{th} upstream optical signal input to the MP to output the results to the first through N^{th} DMPs based on a one-to-one correspondence and performs multiplexing on first through P^{th} downstream optical signals input to the first through P^{th} DMPs to output the results to the MP.

The RN 350 is connected with the CO 310 through the feeder fiber 340 and is connected with ONUs 410-1-1-410-N-M of the first through N^{th} groups 400-1-400-N through corresponding distribution optical fibers. Each of the first through N^{t} groups 400-1-400-N includes first through M^{th} distribution optical fibers. The RN 350 includes a second WDM 360, first through N^{th} distribution units 370-1-370-N, an optoelectric converter (O/E) 380, and a downstream antenna 390.

The second WDM 360 has an MP and first through P^{th} DMPs, in which the MP is connected with the feeder fiber 340, the first through N^{th} DMPs are connected with the first through N^{th} distribution units 370-1-370-N based on a one-to-one correspondence, and the P^{th} DMP is connected with the O/E 380. The second WDM 360 performs de-multiplexing on first through P^{th} downstream optical signals received from the CO 310 to output the results to the first through P^{th} DMPs and performs multiplexing on first through N^{th} upstream optical signals input from the first through N^{th} distribution units 370-1-370-N to output the results to the CO 310.

The first through N^{th} distribution units 370-1-370-N have the same configuration. The N^{th} distribution unit 370-N power-splits an N^{th} downstream optical signal input from the second WDM 360 into M signals and outputs the M signals to the first through N^{th} ONUs 410-N-1-410-N-M of the N^{th} group 410-N.

The N^{th} distribution unit 370-N receives first through M^{th} upstream subcarriers of an N^{th} group wirelessly from the first through M^{th} ONUs 410-N-1-410-N-M of the N^{th} group 410-N and generates an N^{th} upstream optical signal having wavelength λ_{2N}, which is modulated with the first through M^{th} upstream subcarriers, to output the N^{th} upstream optical signal to the second WDM 360. The N^{th} distribution unit 370-N includes an N^{th} CP 372-N, an N^{th} PS 374-N, an N^{th} ULS 378-N, and an N^{th} upstream antenna 376-N.

The N^{th} CP 372-N includes first through third ports, in which the first port is connected with an N^{th} DMP of the second WDM 360, the second port is connected with the N^{th} PS 374-N, and the third port is connected with the N^{th} ULS 378-N. The N^{th} CP 372-N outputs an N^{th} downstream optical signal input from the second WDM 360 to the N^{th} PS 374-N and outputs an N^{th} upstream optical signal input from the N^{th} ULS 378-N to the second WDM 360.

The N^{th} PS 374-N includes an Upstream Port (UP) and first through M^{th} Downstream Ports (DPs), in which the UP is connected with the second port of the N^{th} CP 372-N and the first through M^{th} DPs are connected with distribution optical fibers of the N^{th} group 380-N based on one-to-one correspondence. The N^{th} PS 374-N power-splits an N^{th} downstream optical signal input from the N^{th} CP 372-N into M signals and outputs the M signals to the first through M^{th} DPs.

The N^{th} upstream antenna 376-N is connected with an end of the N^{th} ULS 378-N and outputs first through M^{th} upstream subcarriers of an N^{th} group received wirelessly from first through M^{th} ONUs 410-N-1-410-N-M of the N^{th} group 410-N to the N^{th} ULS 378-N.

One end of the N^{th} ULS 378-N is connected with the N^{th} upstream antenna 376-N and the other end is connected with the third port of the N^{th} CP 372-N. The N^{th} ULS 378-N generates the N^{th} upstream optical signal of the wavelength λ_{2N} which is modulated with the first through M^{th} upstream subcarriers, and outputs the N^{th} upstream optical signal to the N^{th} CP 372-N.

One end of the O/E 380 is connected with the P^{th} DP of the second WDM 360 and the other end is connected with the downstream antenna 390. The O/E 380 receives a P^{th} downstream optical signal from the second WDM 360 to perform optoelectric conversion of the P^{th} downstream optical signal and outputs an M^{th} downstream subcarrier of an N^{th} group, destined to the M^{th} ONU 410-N-M of the N^{th} group 410-1 having a failure, to the downstream antenna 390.

The downstream antenna 390 wirelessly transmits the M^{th} downstream subcarrier of the N^{th} group input from the O/E 380 to the M^{th} ONU 410-N-M of the N^{th} group 410-1.

The ONUs 410-1-1-410-N-M of the first through N^{th} groups 410-1-410-N-M have the same configuration, in which each of the first through N^{th} groups 410-1-410-N-M includes first through M^{th} ONUs that are connected with distribution optical fibers of each group based on a one-to-one correspondence. The M^{th} ONU 410-N-M of the N^{th} group 410-N includes an M^{th} DRX 411-N-M, an M^{th} BPF 412-N-M, an M^{th} frequency modulator 413-N-M, an M^{th} circulator 414-N-M, an M^{th} upstream/downstream antenna 415-N-M, and an M^{th} switch 416-N-M.

One end of the M^{th} DRX 411-N-M is connected with an M^{th} distribution optical fiber of the N^{th} group 400-N and the other end is connected with the M^{th} BPF 412-N-M. In the normal mode, the M^{th} DRX 411-N-M receives an N^{th} downstream optical signal from the M^{th} distribution optical fiber of the N^{th} group 400-N and acquires downstream subcarriers of an N^{th} group from the N^{th} downstream optical signal. In the protection mode, the N^{th} downstream optical signal is not input to the M^{th} DRX 411-N-M.

One end of the M^{th} BPF 412-N-M is connected with the M^{th} DRX 411-N-M and the other end is connected with the M^{th} switch 416-N-M. In the normal mode, the M^{th} BPF 412-N-M receives downstream subcarriers of an N^{th} group from the M^{th} DRX 411-N-M and outputs M^{th} downstream subcarriers acquired by filtering downstream subcarriers of the N^{th} group to the M^{th} switch 416-N-M. The first through (M-1)^{th} downstream subcarriers are removed by the M^{th} BPF 412-N-M. In the protection mode, downstream subcarriers of an N^{th} group are not input to the M^{th} BPF 412-N-M.

The M^{th} frequency modulator 413-N-M is connected with a circulator and generates an M^{th} upstream subcarrier of an N^{th} group having an M^{th} upstream frequency of an N^{th} group, which is modulated with an M^{th} upstream data signal, to output the M^{th} upstream subcarrier to the M^{th} circulator 414-N-M.

The M^{th} upstream/downstream antenna 415-N-M wirelessly transmits an M^{th} upstream subcarrier of the N^{th} group input from the M^{th} circulator 414-N-M to the RN 350 and outputs an M^{th} downstream subcarrier of an N^{th} group received wirelessly from the M^{th} antenna r 415-N-M to the M^{th} circulator 414-N-M.

The M^{th} circulator 414-N-M includes first through third ports, in which the first port is connected with the M^{th} frequency modulator 413-N-M, the second port is connected with the M^{th} upstream/downstream antenna 415-N-M, and the third port is connected with the M^{th} switch 416-N-M. The M^{th} circulator 414 outputs an M^{th} upstream subcarrier of an N^{th} group input to the first port to the upstream/downstream antenna 415 and outputs an M^{th} downstream subcarrier of an N^{th} group input to the second port to the M^{th} switch 416-N-M.

The M^{th} switch 416-N-M includes first through third ports, in which the second port is connected with the other end of the M^{th} BPF 412-N-M and the third port is connected with the third port of the M^{th} circulator 414-N-M. The M^{th} switch 416-N-M connects the first port and the second port in the normal mode and connects the first port and the third port in the protection mode. The M^{th} switch 416-N-M outputs the M^{th} downstream subcarrier of the N^{th} group input to the second port to the first port in the normal mode and outputs the M^{th} downstream subcarrier of the N^{th} group input to the third port to the first port in the protection mode.

The M^{th} ONU 410-N-M of the Nth group 410-N acquires M^{th} downstream data of an N^{th} group from an M^{th} downstream subcarrier of an N^{th} group output from the first port of the M^{th} switch 416-N-M.

To sense the occurrence of a failure, the CO 310 transmits the M^{th} downstream optical signal of the N^{th} group at predetermined intervals even if there is no downstream data to be transmitted to the M^{th} ONU 410-N-M of the N^{th} group 410-N. In addition, the M^{th} ONU 410-N-M of the N^{th} group 410-N senses the occurrence of the failure if a downstream optical signal is not output from the M^{th} switch 416-N-M during a predetermined time period, and switches a connection state of the M^{th} switch 416-N-M. The Mth ONU 410-N-M of the Nth group 410-N wirelessly transmits upstream data notifying the occurrence of the failure to the CO 310.

As described above, the hybrid PON according to the present invention wirelessly transmits upstream subcarriers generated by ONUs to an RN and the RN generates upstream optical signals modulated with the upstream subcarriers, by which the number of required upstream light sources can be reduced and thus a cost for implementing the entire PON can be reduced. Moreover, by using a single upstream light source for each upstream optical signal, Optical Beat Interference (OBI) can be minimized.

Furthermore, in the hybrid PON, if a specific ONU cannot receive a downstream optical signal due to a failure, the RN wirelessly transmits a corresponding downstream subcarrier to the ONU, thereby implementing a self healing function.

While the present invention has been shown and described with reference to preferred embodiments thereof, it will be understood by those skilled in the art that various changes in form and details may be made therein without departing from the spirit and scope of the invention.

What is claimed is:

1. A hybrid Passive Optical Network (PON) using a wireless communication, the hybrid PON comprising:
a Central Office (CO) for transmitting downstream optical signals;
a Remote Node (RN) for:
performing wavelength division demultiplexing on the downstream optical signals received from the CO;
power-splitting each of the demultiplexed downstream optical signals to generate a plurality of downstream optical signals;
transmitting the plurality of downstream optical signals to Optical Network Units (ONUs) of a corresponding group;
generating a corresponding upstream optical signal modulated with wirelessly received upstream subcarriers of a corresponding group;
transmitting a plurality of generated upstream optical signals to the CO; and
a plurality of ONUs, formed into a plurality of groups, each of the ONUs:
acquiring downstream subcarriers of a corresponding group from a corresponding downstream optical signal received from the RN;
acquiring a corresponding downstream subcarrier by filtering downstream subcarriers of the group; and
wirelessly transmitting a corresponding upstream subcarrier to the RN.

2. The hybrid PON of claim 1, wherein the RN comprises:
a Wavelength Division Multiplexer (WDM) for performing wavelength division demultiplexing of the downstream optical signals received from the CO, the WDM including a first bi-directional port and a plurality of second bi-directional ports; and
a plurality of distribution units connected to the WDM, each distribution unit connected to one of the second bi-directional ports,
wherein each of the distribution units comprises:
a power splitter, including a first bi-directional port and a plurality of second bi-directional ports, the power splitter receiving an optical signal on the first bidirectional port, generating a plurality of optical signals by power-splitting the received optical signal and transmitting the plurality of the received optical signal, through corresponding ones of the plurality of second bidirectional ports to ONUs associated with a corresponding group; and
an upstream light source for generating a corresponding upstream optical signal modulated with upstream subcarriers wirelessly received from a corresponding group of ONUs and outputting the upstream optical signal to the WDM.

3. The hybrid PON of claim 2, wherein each of the ONUs comprises:
a downstream optical receiver for acquiring downstream subcarriers of a corresponding group from a corresponding downstream optical signal;
a Bandpass Filter (BPF) for outputting a corresponding one of the downstream subcarriers acquired by filtering downstream subcarriers;
a frequency modulator for outputting a corresponding upstream subcarrier acquired by modulation with a corresponding upstream data signal; and
an antenna for wirelessly transmitting an upstream subcarrier input from the frequency modulator to the RN.

4. The hybrid PON of claim 3, wherein the RN wirelessly transmits a corresponding downstream subcarrier to an ONU when a communication failure with of at least one of the ONUs is detected.

5. The hybrid PON of claim 3, wherein the ONU further comprises:
a switch that is selectively connected with one of the antenna and the BPF according to the occurrence of the failure and outputs a corresponding downstream subcarrier input from the connected one of the antenna and the BPF.

6. The hybrid PON of claim 5, wherein each of the ONUs further comprises:
a circulator for outputting an upstream subcarrier input from the frequency modulator to the antenna and outputting a downstream subcarrier input from the antenna to the switch.

7. A hybrid PON comprising an optical network and a wireless network comprising:
a central office, including a multiplexer for multiplexing and transmitting a plurality of downstream optical signals as a downstream WDM signal and de-multiplexing a received WDM signal into a plurality of upstream optical signals;
a remote terminal including:
a second multiplexer receiving the downstream WDM signal and demultplexing the received WDM signal into a plurality of downstream optical signals; and
a plurality of distribution units, each receiving a selected one of the plurality of downstream optical signals, comprising:
an antenna for receiving an upstream subcarrier wirelessly;
a power splitter for splitting the received downstream signal into a plurality of downstream signals; and
means for distributing the plurality of downstream signals;
a plurality of ONUs, each ONU comprising:
antenna means for transmitting an upstream subcarrier;
filtering means for receiving a downstream signal and isolating a select one of a plurality of subchannels included within said downstream signal.

8. The hybrid PON as recited in claim 7, wherein said remote terminal further comprises:
an additional port for receiving a protection channel; and
means for selective transmitting information associated with the protection channel to a selected one of the ONUs.

9. The hybrid PON as recited in claim 7, wherein the ONU further comprises;
a circulator connected to said antenna; and
a switch connected to the circulator for switching between signals received from the antenna and the filtering means.

10. The hybrid PON as recited in claim 7, the ONU further comprising:
means connected to the antenna means for modulating a data signal onto a subcarrier.

11. The hybrid PON as recited in claim 9, the ONU further comprising:
means connected to the circulator for modulating a data signal onto a subcarrier and
means for transmitting the subcarrier through the antenna.

12. The hybrid PON as recited in claim 7, further comprising:
means for detecting a failure in communication to at least one of the ONUs.

13. The hybrid PON as recited in claim 12, wherein said remote terminal transmits said protection channel information upon detection of said failure.

14. The hybrid PON as recited in claim 12, wherein said switch is positioned to receive said protection channel information upon detection of said failure.

15. The hybrid PON as recited in claim 13, wherein said protection channel information is associated with a subchannel associated with the ONU.
